(19) United States
(12) Patent Application Publication
(10) Pub. No.: US 2013/0050262 A1
(43) Pub. Date: Feb. 28, 2013

(54) METHOD FOR ACCESSING INFORMATION ON CHARACTER BY USING AUGMENTED REALITY, SERVER, AND COMPUTER READABLE RECORDING MEDIUM

(71) Applicant: Seong Il Jeon, Seoul (KR)

(72) Inventor: Seong Il Jeon, Seoul (KR)

(21) Appl. No.: 13/696,306

(22) PCT Filed: May 6, 2011
(86) PCT No.: PCT/KR2011/003392

§ 371 Date: Nov. 5, 2012

(30) Foreign Application Priority Data
May 6, 2010 (KR) 10-2010-0042646

(51) Int. Cl. G09G 5/00

(52) U.S. Cl. 345/633

(57) ABSTRACT

The present invention relates to a method for accessing information of a person by using augmented reality. The method includes the steps of: (a) receiving profile information from multiple users and information on a level of sharing the profile information; (b) checking locations of the multiple users; and (c) allowing a program code for (i) acquiring information on at least one user in close proximity, if it is sensed that a surrounding image is received in a preview state through a terminal of the first user and displaying at least one icon corresponding to the user in close proximity through the terminal of the first user in a form of AR with the surrounding image and (ii) displaying the profile information of a specific user corresponding to a specific icon, if being selected later among the displayed icons, through the screen of the first user to be executed.

### FIELD OF THE INVENTION

The present invention relates to a method, a server, and a computer-readable recording medium for assessing information on a person by using augmented reality (AR); and more particularly, to the method, the server, and the computer-readable recording medium for allowing a user to acquire information on a person of interest immediately and effectively by creating an AR image in use of an image inputted to a terminal and its related information, i.e., information on a profile of the person whom the user wants to access.

### BACKGROUND OF THE INVENTION

Recently, thanks to the development of telecommunication networks and telecommunication devices, it has become generalized to provide a variety of services by using wireless communication technologies.

In particular, a location based service (LBS) may be considered. Such LBS means a service of measuring a location of a portable terminal by using a means of GPS or communications networks and providing a variety of information services in relation to the measured location. As a form of typical terminal location-based service, a personal retrieval service and a map search service, etc. may be served as examples.

Particularly, a personal retrieval service is disclosed in Korean Laid-Open Patent Application No. 10-2006-0027710, etc. The Korean Laid-Open Patent Application discloses a business method that allows a user to search for an acquaintance conveniently and rapidly by using information on customers of wired and wireless telecommunication service providers, which is already stored in databases, and to allow the user to make a telephone call to the acquaintance with his or her consent under the condition that such a call is made without exposing information to each other.

But it was common that such a personal retrieval service cannot provide information of a specific person that a user wants to get and even though the user could get information on the specific person, there was a considerable limit to access the person.

Accordingly, the applicant came to develop a technology of supporting the user to acquire information on a person of interest effectively and immediately by allowing the user to access information on the person through a user-convenient interface.

### SUMMARY OF THE INVENTION

It is an object of the present invention to solve all the problems mentioned above.

It is another object of the present invention to allow a user to get information on a person of interest such as an ideal person by using augmented reality (AR) when the person of interest appears.

It is still another object of the present invention to provide the information on the person of interest while protecting personal privacy by allowing the user to set a subject to share his or her profile information with and preventing other persons from accessing the profile without his or her consent.

It is yet still another object of the present invention to help the service to be activated by sharing at least part of fees paid by others if the user agrees to allow other persons to access his or her profile information.

In accordance with one aspect of the present invention, there is provided a method for accessing information of a person by using augmented reality (AR), including the steps of: (a) receiving profile information from multiple users and information on a level of sharing the profile information; (b) checking locations of the multiple users in real time through location recognition modules embedded in their terminals; and (c) allowing (i) a program code for acquiring information on at least one user in close proximity located within a predetermined distance from a location of a first user, if it is sensed that a surrounding image is received in a preview state through a terminal of the first user and displaying at least one icon corresponding to the user in close proximity through the terminal of the first user in a form of AR with the surrounding image and (ii) a program code for displaying the profile information of a specific user corresponding to a specific icon, if being selected later among the displayed icons, through the screen of the first user to be executed.

In accordance with another aspect of the present invention, there is provided a method for accessing information of a person by using augmented reality (AR), including the steps of: (a) receiving profile information from multiple users; (b) checking locations of the multiple users in real time through location recognition modules embedded in their terminals; and (c) allowing (i) a program code for acquiring information on at least one user in close proximity located within a predetermined distance from a location of a first user, if it is sensed that a surrounding image is received in a preview state through a terminal of the first user and displaying at least one icon corresponding to the user in close proximity through the terminal of the first user in a form of AR with the surrounding image and (ii) a program code for displaying the profile information of a specific user corresponding to a specific icon, if being selected later among the displayed icons, through the screen of the first user to be executed; wherein, at the step (c), if it is sensed that the surrounding image is received in a preview state through the terminal of the first user, the program code is allowed to be executed to display the icon corresponding to the user who is determined to be included in the visual angle of the screen of the first user's terminal among the at least one user in close proximity in a form of AR with the surrounding image.

In accordance with still another aspect of the present invention, there is provided a method for accessing information of a person by using augmented reality (AR), including the steps of: (a) acquiring information on locations of respective multiple users through location recognition modules embedded in their terminals; and (b) acquiring information on at least one user in close proximity located within a predetermined distance from a location of a first user, one of the multiple users, if a surrounding image is received in a preview state through a terminal of the first user and displaying at least one icon corresponding to the user in close proximity therethrough in a form of AR with the surrounding image by referring to the information on the location of the user in close proximity; and (c) displaying profile information of a specific user corresponding to a specific icon among the displayed icons, if being selected, through the screen of the first user; wherein, at the step (b), if the surrounding image is inputted in the preview state through the terminal of the first user, the icon corresponding to the user who is determined to be included in the visual angle of the screen of the first user's terminal among the at least one user in close proximity in a form of AR with the surrounding image.

In accordance with still another aspect of the present invention, there is provided a server for accessing information of a person by using augmented reality (AR), including: a profile information managing part for receiving profile information from multiple users and information on a level of sharing the profile information; a location information managing part for checking locations of the multiple users in real time through location recognition modules embedded in their terminals and acquiring information on at least one user in close proximity located within a predetermined distance from a location of a first user among the multiple users; and a program code execution indicating part for allowing (i) a program code to be executed for displaying at least one icon corresponding to the user in close proximity through the terminal of the first user in a form of AR with a surrounding image by referring to the information on the location of the user in close proximity, if it is sensed that the surrounding image is received in a preview state therethrough, and (ii) a program code to be executed for displaying the profile information of a specific user corresponding to a specific icon, if being selected later among the displayed icons, through the screen of the first user.

In accordance with still another aspect of the present invention, there is provided a server for accessing information of a person by using augmented reality (AR), including: a profile information managing part for receiving profile information from multiple users; a location information managing part for checking locations of the multiple users in real time through location recognition modules embedded in their terminals and acquiring information on at least one user in close proximity located within a predetermined distance from a location of a first user among the multiple users; and a program code execution indicating part for allowing (i) a program code to be executed for displaying at least one icon corresponding to the user in close proximity through the terminal of the first user in a form of AR with a surrounding image, if it is sensed that the surrounding image is received in a preview state therethrough by referring to the information on the location of the user in close proximity and (ii) a program code to be executed for displaying the profile information of a specific user corresponding to a specific icon, if being selected later among the displayed icons, through the screen of the first user; wherein, if it is sensed that the surrounding image is inputted in the preview state through the terminal of the first user, the program code execution indicating part allows the program code for displaying the icon corresponding to the user who is determined to be included in the visual angle of the screen of the first user's terminal among the at least one user in close proximity in a form of AR with the surrounding image to be executed.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram exemplarily representing a configuration of a whole system to access information on a person by using augmented reality (AR) in accordance with one example embodiment of the present invention.

FIG. 2 is a drawing exemplarily representing an internal configuration of a terminal 200 in accordance with one example embodiment of the present invention.

FIG. 3 is a diagram exemplarily showing an internal configuration of an information providing server 300 in accordance with one example embodiment of the present invention.

FIG. 4 is an exemplary drawing showing an icon of a person displayed on a screen of the terminal in a form of AR in accordance with one example embodiment of the present invention.

FIG. 5 is a drawing representing an example of providing profile information of the person if the icon displayed on the screen of the terminal is selected in accordance with one example embodiment of the present invention.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

Configuration of the Whole System

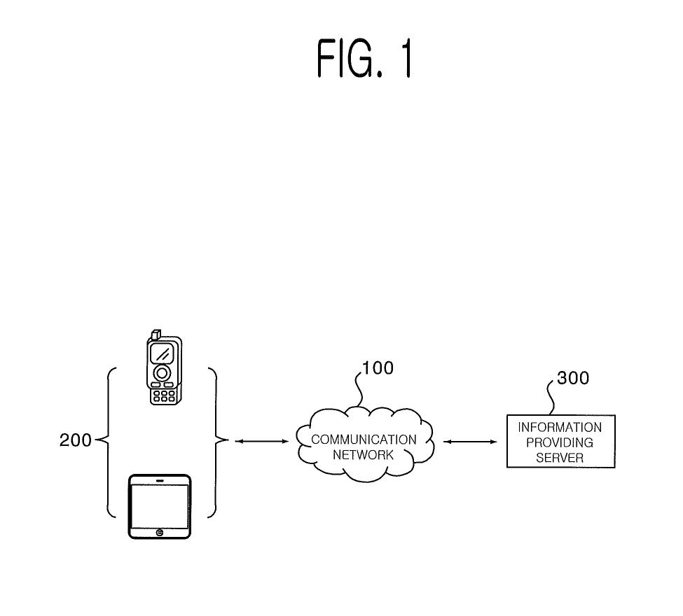

FIG. 1 exemplarily represents a configuration of the whole system to access the information on the person by using the AR in accordance with one example embodiment of the present invention.

As illustrated in FIG. 1, the whole system may include a communication network 100, a terminal 200, and an information providing server 300 in accordance with one example embodiment of the present invention.

First, the communication network 100 in accordance with one example embodiment of the present invention may be configured regardless of wired or wireless and may be configured in a form of a mobile telecommunication network, a local area network (LAN), a metropolitan area network (MAN), a wide area network (WAN), an artificial satellite network and other diverse networks. More particularly, the network 100 in the present invention should be understood as a concept inclusive of all network services such as publicly known World Wide Web (www), Code Division Multiple Access (CDMA), Wideband Code Division Multiple Access (WCDMA), Global System for Mobile communications (GSM) and the like.

Next, the terminal 200 in accordance with an example embodiment of the present invention may perform functions of creating an AR image by using an image inputted through a means of photographing device such as a camera (which must be understood as a concept of including a portable device with a camera) and information relating thereto; displaying a user's or his or her person of interest's current location by referring to location information, etc.; or providing a user-convenient interface that may allow the user to access information on the person of interest by using AR.

In accordance with another example embodiment of the present invention, the terminal 200 means a digital device capable of accessing the communication network 100 and communicating with it. Such digital devices, including a personal computer (e.g., desktop, laptop, tablet PC, etc.), a workstation, a PDA, a web pad, a cellular phone, which have memory means and micro processors with a calculation ability, may be adopted as the terminal 200 in accordance with the present invention. The detailed explanation on an internal configuration and components of the terminal 200 will be made later.

In accordance with another example embodiment of the present invention, the information providing server 300 may perform a function of providing various types of information at the request of the terminal 200 by communicating with the terminal 200 and other information providing servers (not illustrated) through the communication network 100. More specifically, the information providing server 300, which includes a web content searching engine (not illustrated), may search information corresponding to a request of the terminal 200, and allow a user to browse the search result. For example, the information providing server 300 may be an operating server of an internet portal and the information provided to the terminal 200 may be various types of information on a person, map data (including an object corresponding to map data), a website, a web document, knowledge, a blog, a café, an image, a video, news, music, shopping, a book, a movie, etc. Of course, an information search engine of the information providing server 300, if necessary, may be included in an arithmetic and logic unit or a recordable medium other than the server 300. The detailed explanation on an internal configuration and components of the information providing server 300 will be made later.

Configuration of the Terminal

Below will be explanation on an internal configuration and components of the terminal 200 that performs important functions to implement the present invention.

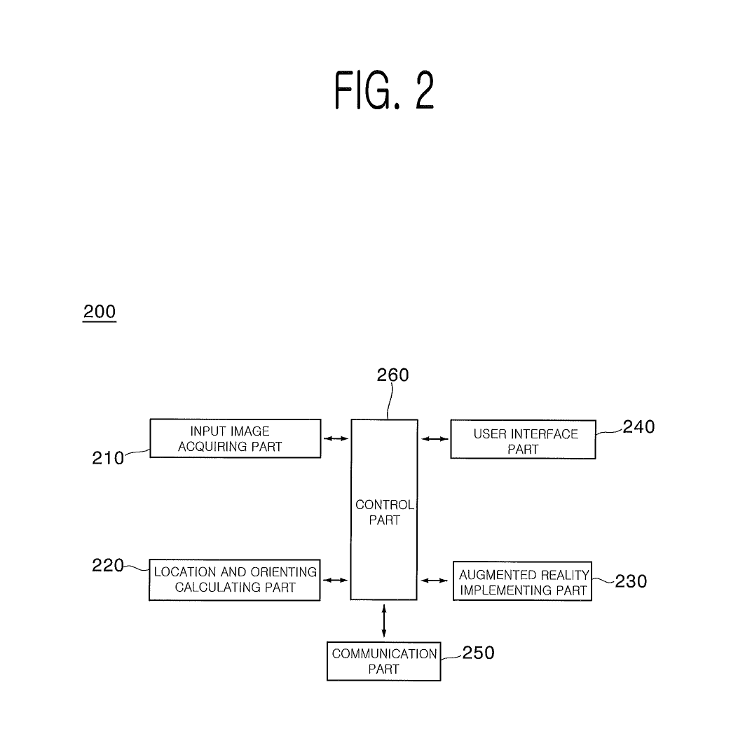

FIG. 2 exemplarily represents an internal configuration of the terminal 200 in accordance with one example embodiment of the present invention.

By referring to FIG. 2, the terminal 200 in accordance with one example embodiment of the present invention may include an input image acquiring part 210, a location and orienting calculating part 220, an augmented reality implementing part 230, a user interface part 240, a communication part 250 and a control part 260. In accordance with one example embodiment of the present invention, at least some of the input image acquiring part 210, the location and orienting calculating part 220, the augmented reality implementing part 230, the user interface part 240, the communication part 250 and the control part 260 may be program modules communicating with the user terminal 200. Such program modules may be included in the terminal 200 in a form of an operating system, an application program module and other program modules. In addition, they may be stored either in various storage devices well known to those skilled in the art or in a remote storage device capable of communicating with the terminal 200. The program modules may include but not be subject to a routine, a subroutine, a program, an object, a component, and a data structure for executing a specific operation or a type of specific abstract data that will be described in accordance with the present invention.

First of all, the input image acquiring part 210 in accordance with one example embodiment of the present invention may perform a function of acquiring an inputted image which becomes a basis of AR to be implemented by the augmented reality implementing part 230, which will be explained below. More particularly, the input image acquiring part 210 in accordance with one example embodiment of the present invention may include a photographing device such as a CCD camera and perform a function of receiving a surrounding landscape of the user who holds the terminal 200 in a preview state.

In accordance with one example embodiment of the present invention, the location and orienting calculating part 220 may also perform a function of calculating a location and an orienting, i.e., positioning, of the terminal 200 in order to determine which region in a real world the inputted image acquired thereby corresponds to.

More specifically, the location and orienting calculating part 220 in accordance with one example embodiment of the present invention may calculate the location of the terminal 200 by using a technology of acquiring location information including a global positioning system (GPS) or other mobile telecommunications technology such as assisted GPS (A-GPS) technology using a network router or a base transceiver station, or a Wi-Fi positioning system (WPS) technology using information on a wireless AP address. For example, to do this, the location and orienting calculating part 220 may include a certain GPS module or a telecommunication module. In addition, the location and orienting calculating part 220 in accordance with one example embodiment of the present invention may calculate an orienting of the terminal 200 by using a sensor. For instance, the location and orienting calculating part 220 may include an accelerometer that senses the existence of motion, distance, speed, acceleration, direction or the like of the terminal 200, a digital compass that senses azimuth angle values, a gyroscope that senses the existence of rotation, rotation value, angular velocity, angular acceleration, direction, etc. thereof, a pressure sensor that may measure an altitude, or the like.

The location and orienting calculating part 220 in accordance with one example embodiment of the present invention may perform a function of specifying the visual field of the terminal 200 corresponding to the image inputted therethrough, based on a visual point, i.e., a location of a lens of the terminal 200, by referring to information on the location, the orienting, and the view angle of the terminal 200 measured as shown above.

More specifically, the visual field of the terminal 200 in accordance with an example embodiment of the present invention means a three-dimensional region in the real world and it may be specified as a viewing frustum whose vertex corresponds to the terminal 200. Herein, the viewing frustum indicates the three-dimensional region included in a visual field of a photographing instrument, such as a camera, if an image is taken by the photographing instrument or inputted in a preview state therethrough. It may be defined as an infinite region in a shape of a cone or a polypyramid according to types of photographing lenses (or as a finite region in a shape of a trapezoidal cylinder or a trapezoidal polyhedron created by cutting the cone or the polypyramid by a near plane or a far plane which is vertical to a visual direction, i.e., a direction of a center of the lens embedded in the terminal 200 facing the real world which is taken by the lens, the near plane being nearer to the visual point than the far plane) based on the center of the lens serving as the visual point.

Next, the augmented reality implementing part 230 in accordance with an example embodiment of the present invention may perform a function of implementing augmented reality by combining the inputted image acquired by the terminal 200 and the information relating to the inputted image to thereby generate an output image visually expressed in a form of the augmented reality. For instance, the augmented reality implementing part 230 in accordance with an example embodiment of the present invention may display a graphic element indicating a point of interest (POI) of an object (e.g., a person, a building, etc.), considered to be included in the visual field of the terminal 200, as the information relating to the inputted image and provide more detailed information on the object if the point of interest is selected by the user. Furthermore, the augmented reality implementing part 230 in accordance with one example embodiment of the present invention would allow information relating to the object, e.g., profile information in case of the person, to be displayed in a form of AR if a graphic element corresponding to the object is sensed to be selected by the user interface part 240 to be explained later.

Next, the user interface part 240 in accordance with one example embodiment of the present invention may display at least one icon, i.e., at least one graphic element, accessible to the information on a profile of the character included in the visual field of the terminal 200 with the inputted image in a form of AR. As well, if a specific icon is selected among the icons displayed in a form of AR, the information on the object corresponding to the specific icon, i.e., the information on the profile of the person, may be displayed. For this, a course of searching the information of the person included in the visual field of the terminal 200 must be preceded. This could be performed by a profile information managing part 310 of the information providing server 300 to be explained later.

The information on the profile of the person displayed with the inputted image in accordance with one example embodiment of the present invention could include a name, an age, a telephone number, an e-mail, an address, an occupation, an ideal type, a today's phrase, etc. of the person. The information on the profile of the person in accordance with the present invention is not only limited to the example embodiments as listed above and the information representing the person may be included in the profile information in accordance with the present invention.

Furthermore, it is said that icons for accessing the information on the profile of persons appearing on the screen of the terminal 200 are displayed in accordance with one example embodiment of the present invention but this is not limited only to this example embodiment and an icon accessible to information on the profile of the person which is located within a predetermined distance from the user, even though the person does not appear on the screen, may be displayed.

In accordance with one example embodiment of the present invention, the communication part 250 may perform a function of allowing the terminal 200 to communicate with an external system such as the information providing server 300.

Finally, the control part 260 in accordance with one example embodiment of the present invention may perform a function of controlling data flow among the input image acquiring part 210, the location and orienting calculating part 220, the augmented reality implementing part 230, the user interface part 240 and the communication part 250. In short, the control part 260 may control the flow of data from outside or among the components of the terminal 200 and thereby allow the input image acquiring part 210, the location and orienting calculating part 220, the augmented reality implementing part 230, the user interface part 240 and the communication part 250 to perform their unique functions.

Configuration of Information Providing Server

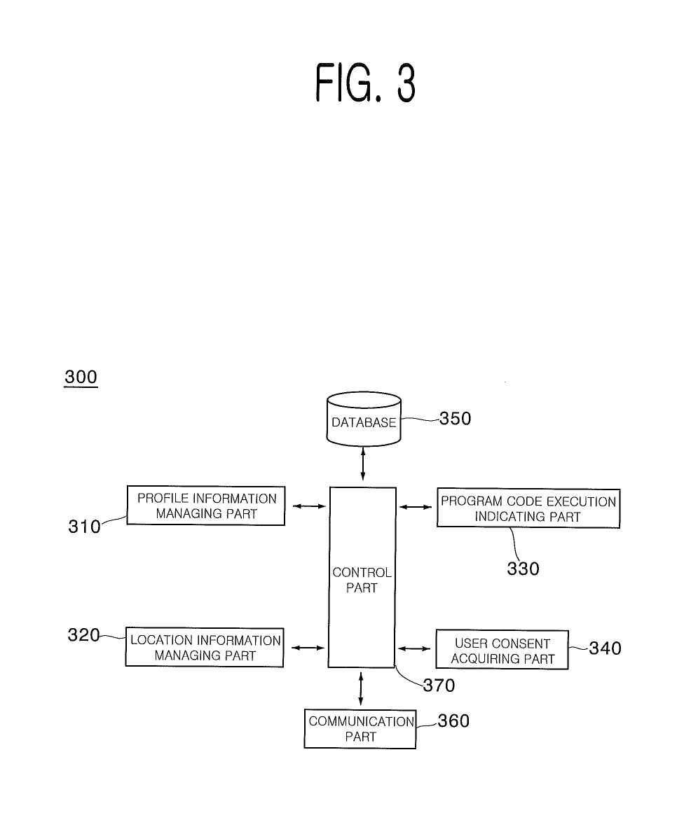

FIG. 3 exemplarily represents an internal configuration of the information providing server 300 in accordance with one example embodiment of the present invention.

By referring to FIG. 3, the information providing server 300 in accordance with one example embodiment of the present invention may include a profile information managing part 310, a location information managing part 320, a program code execution indicating part 330, a user consent acquiring part 340, a database 350, a communication part 360, and a control part 370. In accordance with one example embodiment of the present invention, at least some of the profile information managing part 310, the location information managing part 320, the program code execution indicating part 330, the user consent acquiring part 340, the database 350, the communication part 360 and the control part 370 may be program modules communicating with the information providing server 300. The program modules may be included in the information providing server 300 in a form of an operating system, an application program module and other program modules and may also be stored on several memory devices physically. Furthermore, the program modules may be stored on remote memory devices communicable to the information providing server 300. The program modules may include but not be subject to a routine, a subroutine, a program, an object, a component, and a data structure for executing a specific operation or a type of specific abstract data that will be described in accordance with the present invention.

In accordance with one example embodiment of the present invention, the profile information managing part 310 may perform a function of receiving information on profiles of multiple users and/or information on a sharing level of their profile information. More specifically, the profile information managing part 310 may receive the information on the profiles and/or on the sharing level from respective users and then record the information in the database 350 to be explained later. Herein, the information on the sharing level of the profile information may be a concept of including at least one of a profile information sharing period and a subject to share with.

For example, it could be assumed that a user A of the terminal 200 sets his or her profile information. If the user A sets a period of sharing the profile information as one year in 2008, the profile information of the user A would not be shared in 2010. Furthermore, if subjects to share the profile information of the user A with are women aged between 20 and 30, even if a 35 year old woman satisfies the sharing period, it could be found out that the profile information of the user A is not shared. In short, the profile information of the user A would be shared only with other users who satisfy the condition of the sharing period set by him or her and are included in the subjects to share with.

In accordance with one example embodiment of the present invention, the location information managing part 320 may additionally perform a function of checking locations of multiple users in real time through location recognition modules such as a GPS chip in the terminal 200 held by each of the multiple users.

More specifically, the location information managing part 320 in accordance with the present invention may check the location of users who subscribe a service in the information providing server 300 by referring to the information of each location of the terminal 200 calculated from the location and orienting calculating part 220.

In accordance with one example embodiment of the present invention, the program code execution indicating part 330 may perform functions of transmitting a program code to the terminal 200 to allow a user-convenient interface to be provided to each user's terminal 200 and allowing the transmitted code to be run therein, if there is a certain input from the user later. Herein, a time of transmitting the program code to the terminal 200 will be introduced as various embodiments. For example, a program code may be downloaded from the information providing server 300 and then installed in advance before the terminal 200 moves to an AR mode, or downloaded and installed when the terminal 200 moves to the AR mode.

More specifically, the program code execution indicating part 330 in accordance with one example embodiment of the present invention may allow the program code to be executed to acquire information on a user in close proximity, e.g., users B and C, within a predetermined distance from the location of the user A, from the location information managing part 320, if it is sensed that the surrounding image is inputted in a preview state through the terminal of the user A among multiple users who subscribe a service in the information providing server 300 and allow the program code for displaying icons corresponding to the users B and C through the screen of the user A in a form of AR with the surrounding image to be executed. If a specific icon (e.g., an icon corresponding to, the user C) among the displayed icons is selected, the program code execution indicating part 330 may allow the program code for displaying information on the profile of the user C through the screen of the user A in a form of AR to be executed.

At the time, the program code execution indicating part 330 may allow the program code to determine whether the information on the users B and C is displayed on the screen of the user A by referring to information on subjects to share with and/or a sharing period included in the profile information of the users B and C when the icons on the users B and C are displayed through the screen of the user A or the profile information of the user C, etc. is display through the screen of the user A. For example, if only the user B includes the user A as a subject to share with (i.e., assuming that only the user B sets that his or her own information is shared with the user A), the program code execution indicating part 330 may allow the program code for displaying only information on the user B only through the screen of the user A in a form of icon to be executed or allow the program code for displaying only the profile information of the user B, even though the icons for the users B and C are all displayed, to be executed. Herein, the information of the user B will be displayed only if the condition for the sharing period included in the information of the user B is satisfied.

Besides, if it is sensed through the terminal of the user A that the surrounding image is received in the preview state, the program code execution indicating part 330 in accordance with one example embodiment of the present invention may allow the program code for displaying icons corresponding to users D, E, etc. included in the field of view of the screen of the user A's terminal among users within the pre-determined distance from the location of the user A to be executed. Herein, the program code execution indicating part 330 may allow the program code for displaying only an icon corresponding to a user of interest, i.e., a user E, through the screen of the user A by referring to the information on the persons of interest, e.g., an ideal person, included in the profile information of the user A to be executed.

If the user A sets a specific icon (e.g., a specific icon corresponding to the user E) as a subject to be tracked among icons displayed on his or her terminal, the program code execution indicating part 330 in accordance with one example embodiment of the present invention may additionally allow the user A to receive a feedback of whether the location of the user E is within the predetermined distance from that of the user A in real time from the location information managing part 320 and if the user A gets the feedback that the user E is within the predetermined distance from the location of the user A, the program code execution indicating part 330 may allow the program code to be executed to provide an alarm to inform the user A of the information.

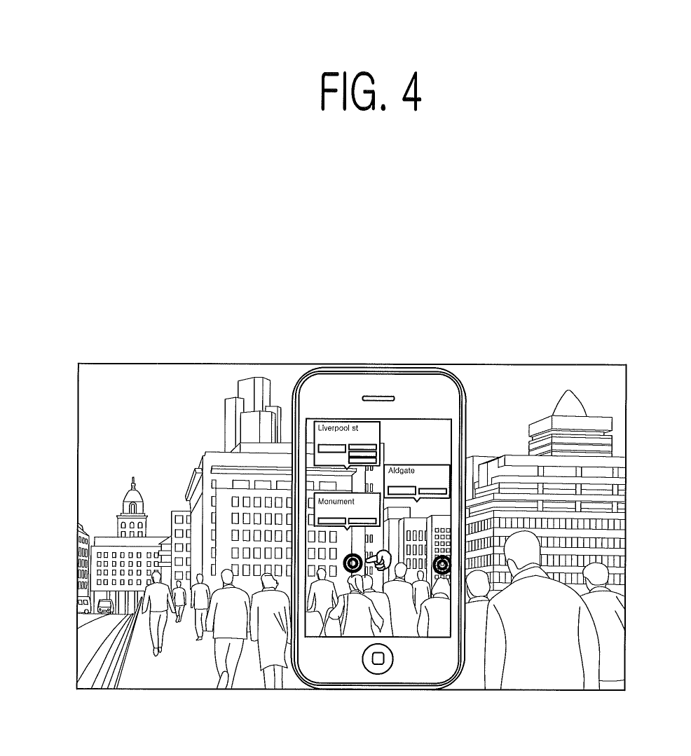

By referring to FIG. 4, it can be found out that when the users B and C are located within the predetermined distance from the user A, e.g., 10M, and within the field of view of the user A's terminal, the icons of the users B and C may be displayed through the screen of the user A. At the time, when the icons of the users B and C are displayed on the screen of the user A's terminal, it may be because the users B and C correspond to the persons of interest of the user A or because the user A may be included in the subjects to share the information of the users B and C with.

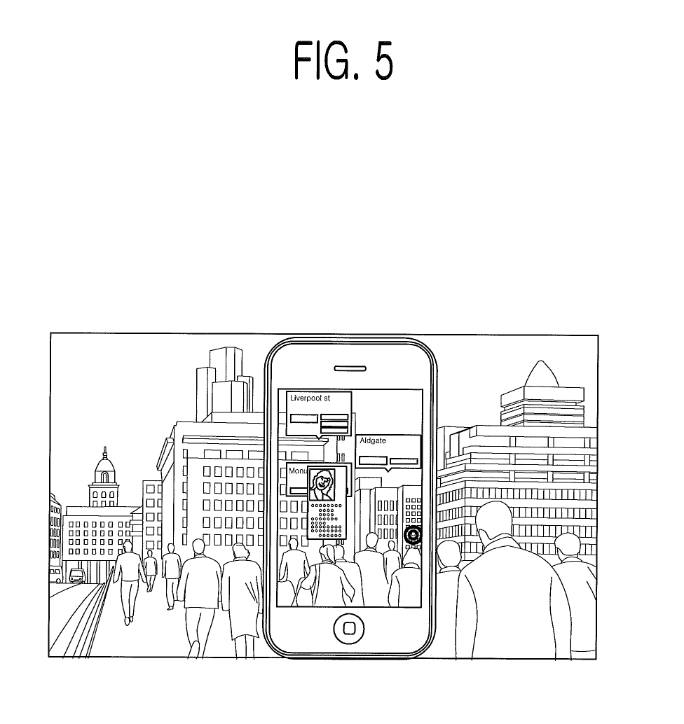

In FIG. 4, if the icon corresponding to the user B among the displayed icons of the users B and C is selected by the user A, the profile information of the user B is displayed immediately on the screen of the user A's terminal as shown in FIG. 5 or the information of the user B is provided only after the consent of the user B (This will be explained right below).

If the user A requests to access the profile information of the user B, the user consent acquiring part 340 in accordance with one example embodiment of the present invention may perform a function of transmitting a message of asking a consent for an information inquiry by the user A to the user B's terminal. At the time, if the user consent acquiring part 340 receives a consent message from the user B, a charging part (not illustrated) may charge a certain amount of fee to the user A and allow the profile information managing part 310 to provide the user A with the information of the user B. Furthermore, the charging part may share at least some of the certain amount of fee to the user B. At the time, the user B may gradually set the confidentiality level regarding his or her profile information but in such case, if it is assumed that the profile information corresponding to level 1 includes a name and an age and that corresponding to level 2 includes a telephone, an address, etc., it will be able to reproduce the present invention by applying various examples including giving grades in benefits to the user B depending on whether the profile information corresponding to level 1 or level 2 is allowed by the user B to be shared.

In accordance with one example embodiment of the present invention, the database 350 is a concept of a database not only in a narrow meaning but also in a broad meaning which include data records, etc. based on computer file systems. From the aspect, it must be understood that, even a set of simple operation processing logs may be the database(s) in the present invention if data can be extracted from the set. In addition, the database 350 in FIG. 3 is illustrated to be configured inclusively in the information providing server 300 but the database 350 may be configured separately from it by those skilled in the art.

In accordance with one example embodiment of the present invention, the communication part 360 may perform a function of allowing the information providing server 300 to communicate with an external system such as the terminal 200.

Finally, the control part 370 in accordance with one example embodiment of the present invention may perform a function of controlling data flow among the location information managing part 320, the program code execution indicating part 330, the user consent acquiring part 340, the database 350 and the communication part 360.

In short, the control part 370 may control the flow of data from outside or among the components of the information providing server 300 and thereby allow the profile information managing part 310, the location information managing part 320, the program code execution indicating part 330, the user consent acquiring part 340, the database 350 and the communication part 360 to perform their unique functions.

In accordance with the present invention, the user may achieve the effect of extremely simply acquire information on persons of interest appearing in the view field of the terminal because the information on the persons of interest appearing in the view field of the terminal may be displayed in a form of AR in addition to the inputted image in the preview state.

In accordance with the present invention, if the user sets a specific person as a person of interest, the user may fulfill his or her curiosity because an alarm may be given to the user when the person of interest approaches the user within the predetermined distance.

1. A method for accessing information of a person by using augmented reality (AR), comprising the steps of:
(a) receiving profile information from multiple users and information on a level of sharing the profile information;
(b) checking locations of the multiple users in real time through location recognition modules embedded in their terminals; and
(c) allowing (i) a program code for acquiring information on at least one user in close proximity located within a predetermined distance from a location of a first user, if it is sensed that a surrounding image is received in a preview state through a terminal of the first user and displaying at least one icon corresponding to the user in close proximity through the terminal of the first user in a form of AR with the surrounding image and (ii) a program code for displaying the profile information of a specific user corresponding to a specific icon, if being selected later among the displayed icons, through the screen of the first user to be executed.

2. The method of claim 1, wherein, at the step (a), profile information of the respective multiple users and information on the level of sharing are recorded in a database.

3. The method of claim 1, wherein the information on the level of sharing includes at least one of a profile information sharing period and a subject to share the profile information with.

4. The method of claim 3, wherein the step (c) includes the step of allowing the program code for displaying the icon corresponding to the user in close proximity who is determined to include the first user in the subject to share with through the screen of the terminal of the first user by referring to the information on the subject to share with included in the profile information of the user in close proximity to be executed.

5. The method of claim 4, wherein the step (c) includes the step of allowing the program code for displaying the icon corresponding to the user who is determined to be included in the sharing period and at the same time includes the first user in the subjects to share with through the screen of the first user by additionally referring to information on the sharing period included in the profile information of the user in close proximity to be executed.

6. A method for accessing information of a person by using augmented reality (AR), comprising the steps of:
(a) receiving profile information from multiple users;
(b) checking locations of the multiple users in real time through location recognition modules embedded in their terminals; and
(c) allowing (i) a program code for acquiring information on at least one user in close proximity located within a predetermined distance from a location of a first user, if it is sensed that a surrounding image is received in a preview state through a terminal of the first user and displaying at least one icon corresponding to the user in close proximity through the terminal of the first user in a form of AR with the surrounding image and (ii) a program code for displaying the profile information of a specific user corresponding to a specific icon, if being selected later among the displayed icons, through the screen of the first user to be executed;
wherein, at the step (c), if it is sensed that the surrounding image is received in a preview state through the terminal of the first user, the program code is allowed to be executed to display the icon corresponding to the user who is determined to be included in the visual angle of the screen of the first user's terminal among the at least one user in close proximity in a form of AR with the surrounding image.

7. The method of claim 6, wherein, at the step (c), the program code is executed to display only the icon corresponding to the user who is determined to be a person of interest through the screen of the first user by referring to information on the persons of interest included in the profile information of the first user.

8. The method of claim 1, further comprising the steps of:
(d) sensing whether there is the specific user that corresponds to the specific icon within a certain distance from the first user, if the specific user is recognized to have been selected as a subject to be tracked by the first user; and
(e) allowing the program code for providing an alarm to the first user, if it is sensed that there is the specific user as the subject to be tracked within the certain distance from the location of the first user, to be executed.

9. The method of claim 1, wherein the step (c) includes the steps of:
(c1) transmitting a consent of information inquiry by the first user to a terminal of the specific user corresponding to the specific icon, if the specific icon is recognized to have been selected by the first user; and
(c2) charging a certain amount of fee to the first user, if a consent message is received from the specific user corresponding to the specific icon, and providing the first user with information on the specific user.

10. The method of claim 9, wherein the step (c) further includes the step of:
(c3) providing at least some of the certain amount of the fee for the specific user corresponding to the specific icon.

11. A method for accessing information of a person by using augmented reality (AR), comprising the steps of:
(a) acquiring information on locations of respective multiple users through location recognition modules embedded in their terminals; and
(b) acquiring information on at least one user in close proximity located within a predetermined distance from a location of a first user, one of the multiple users, if a surrounding image is received in a preview state through a terminal of the first user and displaying at least one icon corresponding to the user in close proximity therethrough in a form of AR with the surrounding image by referring to the information on the location of the user in close proximity; and
(c) displaying profile information of a specific user corresponding to a specific icon among the displayed icons, if being selected, through the screen of the first user;
wherein, at the step (b), if the surrounding image is inputted in the preview state through the terminal of the first user, the icon corresponding to the user who is determined to be included in the visual angle of the screen of the first user's terminal among the at least one user in close proximity in a form of AR with the surrounding image.

12. A server for accessing information of a person by using augmented reality (AR), comprising:
a profile information managing part for receiving profile information from multiple users and information on a level of sharing the profile information;
a location information managing part for checking locations of the multiple users in real time through location recognition modules embedded in their terminals and acquiring information on at least one user in close proximity located within a predetermined distance from a location of a first user among the multiple users; and
a program code execution indicating part for allowing (i) a program code to be executed for displaying at least one icon corresponding to the user in close proximity through the terminal of the first user in a form of AR with a surrounding image by referring to the information on the location of the user in close proximity, if it is sensed that the surrounding image is received in a preview state therethrough, and (ii) a program code to be executed for displaying the profile information of a specific user corresponding to a specific icon, if being selected later among the displayed icons, through the screen of the first user.

13. The server of claim 12, wherein the profile information managing part records the profile information of the respective multiple users and the information on the level of sharing the profile information.

14. The server of claim 12, wherein the information on the level of sharing includes at least one of a profile information sharing period and a subject to share the profile information with.

15. The server of claim 14, wherein the program code execution indicating part allows a program code to be executed for displaying the icon corresponding to the user in close proximity who is determined to be include the first user in the subject to share with by referring to the information on the subject to share with included in the profile information of the user in close proximity.

16. The server of claim 15, wherein the program code execution indicating part allows a program code to be executed for displaying the icon corresponding to the user who is determined to be included in the sharing period and at the same time includes the first user in the subject to share with through the screen of the first user by additionally referring to information on the sharing period included in the profile information of the user in close proximity.

17. A server for accessing information of a person by using augmented reality (AR), comprising:
a profile information managing part for receiving profile information from multiple users;
a location information managing part for checking locations of the multiple users in real time through location recognition modules embedded in their terminals and acquiring information on at least one user in close proximity located within a predetermined distance from a location of a first user among the multiple users; and
a program code execution indicating part for allowing (i) a program code to be executed for displaying at least one icon corresponding to the user in close proximity through the terminal of the first user in a form of AR with a surrounding image, if it is sensed that the surrounding image is received in a preview state therethrough by referring to the information on the location of the user in close proximity and (ii) a program code to be executed for displaying the profile information of a specific user corresponding to a specific icon, if being selected later among the displayed icons, through the screen of the first user;
wherein, if it is sensed that the surrounding image is inputted in the preview state through the terminal of the first user, the program code execution indicating part allows the program code for displaying the icon corresponding to the user who is determined to be included in the visual angle of the screen of the first user's terminal among the at least one user in close proximity in a form of AR with the surrounding image to be executed.

18. The server of claim 17, wherein the program code execution indicating part allows the program code for displaying only the icon corresponding to the user who is determined to be a person of interest through the screen of the first user by referring to information on the persons of interest included in the profile information of the first user to be executed.

19. The server of claim 12, further comprising:
a user consent acquiring part for transmitting a consent of information inquiry by the first user to a terminal of the specific user corresponding to the specific icon, if the specific icon is recognized to have been selected by the first user;
wherein the user consent acquiring part allows a charging part to charge a certain amount of fee to the first user, if a consent message is received from the specific user corresponding to the specific icon, and allows the profile information managing part to provide the first user with information on the specific user.

20. The server of claim 19, wherein the charging part provides at least some of the certain amount of the fee for the specific user corresponding to the specific icon.

21. A medium recording a computer readable program to execute the method of claim 1.
